(19) United States
(12) Patent Application Publication
(10) Pub. No.: US 2013/0315809 A1
(43) Pub. Date: Nov. 28, 2013

(54) METHOD OF CONTROLLING CO2 CHEMICAL ABSORPTION SYSTEM

(71) Applicant: Jun Shimamura, Hiroshima (JP)

(72) Inventor: Jun Shimamura, Hiroshima (JP)

(73) Assignee: BABCOCK-HITACHI KABUSHIKI KAISHA, Tokyo (JP)

(21) Appl. No.: 13/984,539

(22) PCT Filed: Feb. 14, 2012
(86) PCT No.: PCT/JP2012/053349

§ 371 Date: Aug. 9, 2013

(30) Foreign Application Priority Data
Feb. 14, 2011 (JP) 2011-028770

(51) Int. Cl. B01D 53/62

(52) U.S. Cl. CPC B01D 53/62
USPC 423/228; 422/173

(57) ABSTRACT

In a system of absorbing CO₂ from exhaust gas comprising absorbent regeneration equipment (a reclaimer), the present invention solves a problem of a water balance associated with operation of the reclaimer to keep the CO₂ absorption system under optimal conditions. A method of controlling a CO₂ chemical absorption system comprising CO₂ chemical absorption equipment and absorbent regeneration equipment, the CO₂ chemical absorption equipment being involved in contacting CO₂ in exhaust gas with amine absorbent in an absorber column, heating the CO₂ absorbed absorbent in a desorber column to release CO₂, cooling the CO₂ removed exhaust gas to separate condensed water, and circulating the condensed water to the desorber column; and the absorbent regeneration equipment being involved in withdrawing the amine absorbent from the desorber column, removing heat stable salts accumulated in the amine absorbent by a distillation process, and then supplying resultant vapor of the amine absorbent to the desorber column, the method comprising: rerouting some of condensed water obtained by cooling the CO₂ removed exhaust gas in the desorber column, and adding a solution of an inorganic alkaline salt as a solvent to the absorbent regeneration equipment to remove heat stable salts accumulated in the amine absorbent in the distillation process.

### TECHNICAL FIELD

The present invention relates to a method of controlling a carbon dioxide (CO₂) chemical absorption system. In particular, the prevent invention relates to a method of controlling a carbon dioxide (CO₂) chemical absorption system comprising a distillation reclaimer, the method allowing the system to be operated with minimum makeup water while maintaining a water balance in CO₂ recovery equipment.

### BACKGROUND ART

In recent years, in thermal power generation facilities and boiler equipment, a large amount of coal, heavy oil and the like are used as fuel, raising an issue of extensive discharge of CO₂ to the atmosphere in terms of air pollution and global warming. For one of the separation and recovery technologies of CO₂, a chemical absorption method using an amine compound such as alkanolamine is widely known.

FIG. 3 shows an embodiment of a power generation plant comprising a conventional CO₂ chemical absorption system. The power generation plant mainly comprises Boiler 1, Denitration Device 2, Air Heater 3, Electrostatic Precipitator 4, Wet Desulfurization Device 5, Pre-scrubber 10, CO₂ Absorber Column 20, Desorber Column 40, Reboiler 60 and the like. Combustion exhaust gas generated by combustion of fossil fuels such as coal and discharged from Boiler 1 is passed through Denitration Device 2 to remove nitrogen oxide, and then passed through Air Heater 3 for heat exchange and cooled down to, for example, 120° C. to 170° C. The exhaust gas passed through Air Heater 3 is passed through Electrostatic Precipitator 4 to remove soot dust in the exhaust gas, and further pressurized by an induced draft fan, and then subjected to Wet Desulfurization Device 5 to remove sulfur oxide (SO₂). About 10 ppm of SO₂ usually remains in the outlet gas from Wet Desulfurization Device 5. In order to prevent deterioration of CO₂ absorbent in CO₂ Absorber Column 20 by the residual SO₂, Pre-scrubber 10 is provided as a pretreatment device for CO₂ chemical absorption equipment to reduce the amount of residual SO₂ as much as possible at this stage (for example, 1 ppm or less).

CO₂ Absorber Column 20 comprises Packed Bed 21, which is a main CO₂ absorbing section, Absorbent Spray Section 22, Water Washing Section 24, Washing Water Spray Section 25, Demister 26, Washing Water Reservoir 27, Condenser 28 and Washing Water Pump 29. CO₂ contained in exhaust gas is absorbed into CO₂ absorbent in Packed Bed 21 by gas-liquid contacts with CO₂ absorbent supplied from a CO₂ absorbent spray section located at the upper part of CO₂ Absorber Column 20. In Water Washing Section 24, De-CO₂ Gas 23 heated by the exothermic reaction of absorption is cooled, and mist coming along with the gas is removed. Further, washing water cooled by Condenser 28 is recirculated for use through Washing Water Pump 29. After removing mist coming along with the gas by Demister 26 provided above Water Washing Section 24, the gas is discharged out of the system as Treated Gas 37 (de-CO₂ gas).

The CO₂ absorbed absorbent is withdrawn from a liquid reservoir provided at the lower part of Absorber Column 20 with Absorber Column Withdrawal Pump 33, heated by Heat Exchanger 34 and then passed to Desorber Column 40. In Desorber Column 40, the CO₂ enriched absorbent which is sprayed from Spray Section 42 is fed to Packed Bed 41. Meanwhile, vapor is supplied to the bottom of Desorber Column 40 from Reboiler 60 via Vapor Supply Line 65. In Packed Bed 41, the CO₂ enriched absorbent makes gas-liquid contacts with vapor coming up from the bottom to degas CO₂ in the absorbent to the gas phase. Mist of some absorbent coming along with the degassed CO₂ gas is removed with Water Washing Section 43. Demister 45 provided above Water Washing Section 43 removes the mist coming along with the gas from Water Washing Section 43 and the like, and then the gas is discharged from the top of Desorber Column 40 as CO₂ Gas 46. Then, the CO₂ gas is cooled down to about 40° C. in Condenser 47, and then separated into gas and condensed water in CO₂ Separator 48. The separated CO₂ gas is introduced to CO₂ Liquefying Device (not shown) while the condensed water is supplied to Water Spray Section 44 in Desorber Column 40 through Line 49 by Drain Pump 50.

Meanwhile, the CO₂ absorbent from which CO₂ is degassed is pooled in Desorber Column Liquid Reservoir 51, and then passed to Reboiler 60 through Reboiler Liquid Feeding Line 52. A heat exchanger tube and the like is provided inside Reboiler 60, in which vapor is generated by indirectly heating the CO₂ absorbent with steam 62 supplied through a steam supply line. The vapor is then supplied to the desorber column through Vapor Supply Line 65. Steam 62 used in Reboiler 60 is returned to drain water in the heat exchanger tube, and collected. The CO₂ absorbent pooled in the liquid reservoir at the bottom of Desorber Column 40 is passed through Desorber Column Withdrawal Line 66 to Heat Exchanger 34 and Condenser 29 for cooling, and then returned to the CO₂ absorber column.

Meanwhile, most of slightly SO₂ contained in the exhaust gas fed to Absorber Column 20 reacts with CO₂ absorbent to form heat stable salts (abbreviated as HSS). Because the reaction is irreversible, the reactivity of the CO₂ absorbent and CO₂ is lost while HSS is dissolved and still present in the absorbent. Therefore, the equilibrium between amine and CO₂ is increasingly disturbed as the concentration of HSS increases, leading to increased CO₂ desorbing energy. To this end, Side Stream Regeneration Distiller (may be termed as a reclaimer) 94 is provided in order to remove this HSS. Some of absorbent in which heat stable salts are accumulated to some extent is withdrawn to Reclaimer 94 where inorganic alkali salts such as sodium carbonate (Na₂CO₃), potassium carbonate and the like are added through an inorganic alkali salt addition line to remove heat stable salts from absorbent as corresponding sulfates. Reclaimer 94 is operated as follows. First, the operation of CO₂ Absorber Equipment 20 is stopped. The CO₂ absorbent from which CO₂ is degassed is fed to Reclaimer 94 via Flowmeter 92 and Cutoff Valve 91. The flowmeter monitors an amount of liquid introduced to Reclaimer 94 with Pump 93. The CO₂ absorbent is monitored for a water level with Level Transmitter 95 provided in Reclaimer 94, and fed until fully filled. Upon filled to the full capacity, Cutoff Valve 91 is closed. By pre-feeding a Na based alkali solution such as Na₂CO₃ in Reclaimer 94, HSS in an amine solution reacts with the alkali solution, i.e., S attached to amine dissociates to give Na₂SO₄. Next, by opening Cutoff Valve 98 to supply high temperature steam via Steam Supply Line 96, the CO₂ absorbent is allowed to be boiled and evaporated. The temperature of the steam supplied to Reclaimer 94 through Steam Supply Line 96 is usually higher than that used in Reboiler 60 in order to separate amine from Na₂SO₄ by boiling and evaporating amine. The temperature of the steam for Reboiler 60 is selected in order to avoid pyrolysis of amine. The evaporated CO₂ absorbent is returned to Desorber Column 40 through Amine Vapor Line 97. The amine absorbent ascending along Desorber Column 40 is cooled in Water Washing Section 43, and further cooled down to about 40° C. in Condenser 47 to be liquefied. Then it is returned to Desorber Column 40 after passed through CO₂ Separator 48 and Drain Pump 50. Meanwhile, in Reclaimer 94, Na₂SO₄ is gradually concentrated while amine and the like is evaporated. When a water level falls to a specified level, the steam supply to Reclaimer 94 is stopped. Cutoff Valve 98 is closed, and Cutoff Valve 100 provided at Amine Waste Line 99 is opened to discharge amine waste containing Na₂SO₄ to Amine Waste Tank 101.

In the reclaimer, for example, a base such Na₂CO₃ is introduced, and amine and Na₂SO₄ are separated. Na₂SO₄ is discharged out of the system while amine absorbent is returned to the absorber column. In this case, quantitative feeding of Na₂CO₃ and the like is difficult from an engineering standpoint because Na₂CO₃ is in a form of powder. Therefore, Na₂CO₃ is first dissolved in water in a buffer tank and the like, and then introduced to the system as an aqueous solution.

Meanwhile, with regard to a water balance in the CO₂ recovery equipment, inlet gas is usually saturated at 40° C. while outlet gas from the absorber column and the desorber column is also saturated at the same temperature of 40° C. Therefore, almost no additional water is supplied. Specifically, only about 50 kg/h of makeup water can be added for a CO₂ recovery plant of about 100 t/d. A processing speed of a reclaimer is usually less than 1% of the amine circulation volume to circulate. In the case that the volume is set to 0.5% and a concentration of HSS in a system is 2 wt %, about 10 kg/h of Na₂CO₃ is required. To dissolve this amount of Na₂CO₃ in water, about 3 times of that weight, i.e. 30 kg/h of water is required. Adding more makeup water to the system is difficult in view of amine supply and prevention of amine concentration in washing water used for Water Washing Section 24.

### SUMMARY OF THE INVENTION

### Problems to be Resolved by the Invention

In the above-mentioned conventional art, with regard to a water balance in the recovery equipment, inlet gas is saturated at 40° C. while outlet gas from the absorber column and the desorber column is also saturated at the same temperature of 40° C. Therefore, a problem is that almost no makeup water can be supplied. Further, another problem is that adding more makeup water to the system is difficult in view of amine supply and prevention of amine concentration in washing water used for Water Washing Section 24. Therefore, there have been the following problems. In order to operate a reclaimer under these circumstances, a water balance in CO₂ absorption equipment has to be disregarded. Alternatively, in order to maintain a water balance, temperature of outlet gas has to be changed to increase an amount of released water. Changing a water balance and reducing a concentration of amine is not preferable because excess water needs to be heated in a desorber column and an increased amount of steam 62 is required, resulting in an increased utility cost.

An object of the present invention is to solve a problem of a water balance associated with operation of a reclaimer in a CO₂ absorption system having the conventional reclaimer to minimize water supply from the outside of the system so that the CO₂ absorption system is kept in optimal conditions.

### Means for Solving the Problems

Referring to the conventional system in FIG. 3, the above object is achieved by rerouting condensed water separated in CO₂ Separator 48 to Adjustment Tank 83 via Drain Line 49 and Drain Pump 50 to pool some of drain water which is otherwise returned to Desorber Column 40 via Water Washing Spray Section 44; adjusting a liquid level in Adjustment Tank 83 with Flow Regulating Valve 81; introducing a solid base such as Na₂CO₃ through Feeder 84 having weight monitoring capability to adjust a concentration of a Na₂CO₃ solution; and feeding an appropriate amount of the Na₂CO₃ solution depending on an amount of HSS in absorbent to Reclaimer 94 or Amine Supply Line 102 upstream of Reclaimer 94.

That is, the inventions claimed in the present application are as follows.

(1) A method of controlling a CO₂ chemical absorption system comprising CO₂ chemical absorption equipment and absorbent regeneration equipment, the CO₂ chemical absorption equipment being involved in removing sulfur oxides in exhaust gas discharged from combustion equipment of fossil fuel by a flue gas desulfurization device, then contacting the exhaust gas with amine absorbent in a carbon dioxide (CO₂) absorber column to absorb CO₂ in the exhaust gas, subsequently heating the CO₂ absorbed absorbent in a desorber column to release CO₂, cooling the CO₂ removed exhaust gas to separate condensed water, circulating the separated condensed water to the desorber column, heating the CO₂ released absorbent through a reboiler for circulation in the desorber column, heat exchanging the amine absorbent withdrawn from the desorber column with the amine absorbent to be supplied to the desorber column for circulation in the desorber column; and the absorbent regeneration equipment being involved in withdrawing the amine absorbent from the desorber column, removing heat stable salts accumulated in the amine absorbent by a distillation process, and then supplying resultant vapor of the amine absorbent to the desorber column, the method comprising rerouting some of condensed water obtained by cooling the CO₂ removed exhaust gas in the desorber column, and adding a solution of an inorganic alkali salt as a solvent to the absorbent regeneration equipment to remove heat stable salts accumulated in the amine absorbent in the distillation process.
(2) The method according to (1) comprising: temporarily pooling the rerouted condensed water in an adjustment tank; adding inorganic alkali to the tank to adjust a concentration of the inorganic alkali and a liquid level; then adjusting an amount of the solution of the inorganic alkali salt in the adjustment tank, depending on a concentration of the heat stable salts in the absorbent to be supplied to the absorbent regeneration equipment; and adding the adjusted amount of the solution of the inorganic alkali salt to the absorbent regeneration equipment.
(3) The method according to (2), wherein the inorganic alkali solution is added by pumping to an absorbent supply line leading to the absorbent regeneration equipment.

### Advantageous Effects of the Invention

According to the present invention, a water balance in a system can be kept constant similarly as when a reclaimer is not operated because there is no water supply from the outside of the system. The water supply from the outside of the system is a factor responsible for a disturbed water balance. Therefore the CO₂ absorption system can be stably operated.

### BRIEF DESCRIPTION OF THE DRAWINGS

FIG. 1 is an explanatory diagram of a CO₂ absorption system showing one

Embodiment of the present invention.

FIG. 2 is an explanatory diagram of a CO₂ absorption system showing another Embodiment of the present invention.

FIG. 3 is an explanatory diagram showing a conventional CO₂ absorption system.

### EMBODIMENTS FOR CARRYING OUT THE INVENTION

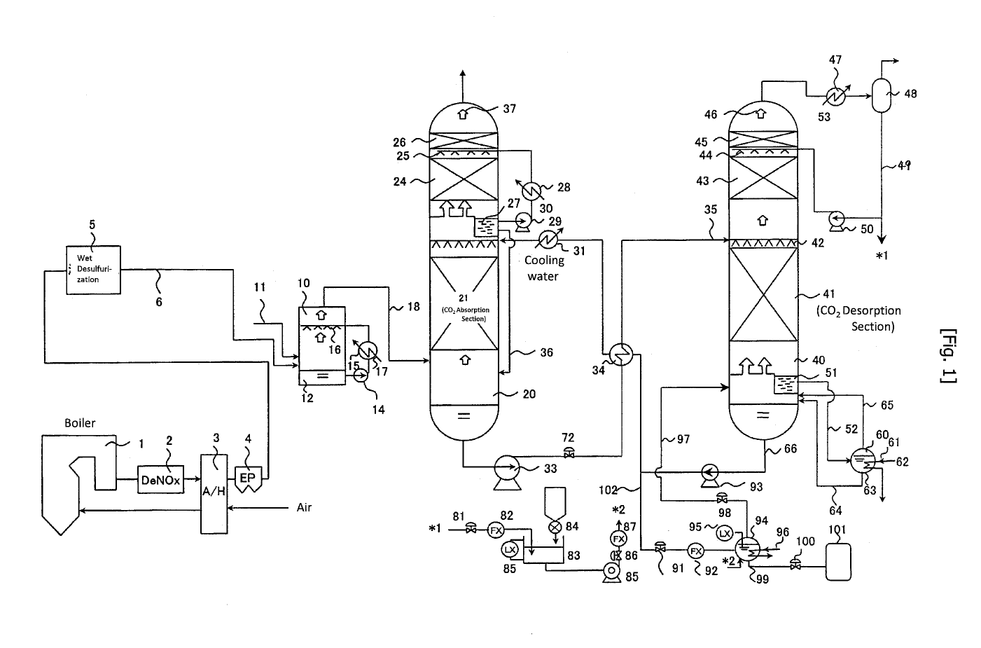

FIG. 1 is an explanatory diagram of a CO₂ absorption system showing one

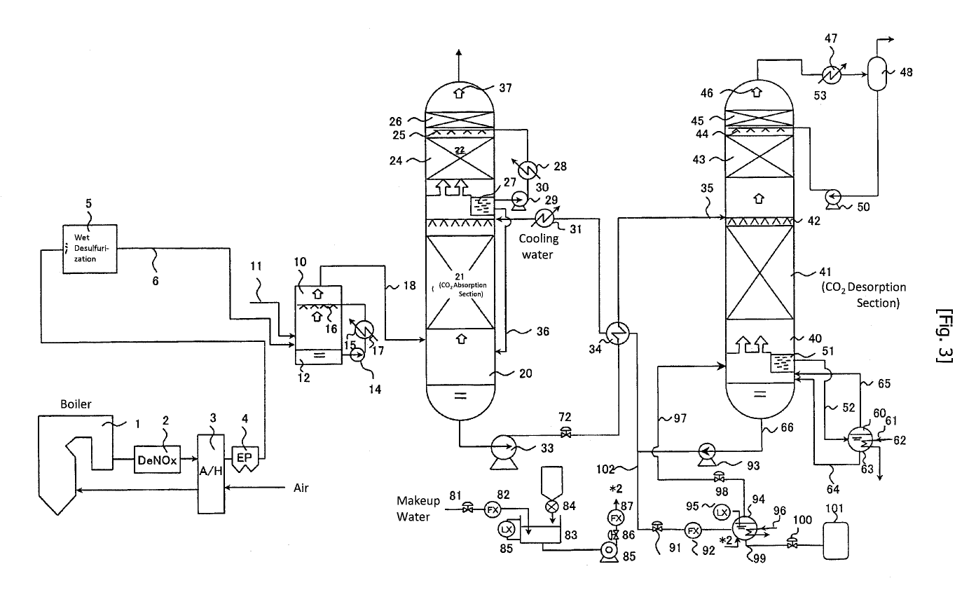

Embodiment of the present invention. The present invention differs from the conventional system in FIG. 3 in that instead of supplying water from the outside, some of drain water separated in CO₂ separator 48 and present in Line 49 is pooled in Reservoir Tank 83 depending on a liquid level, and a solid base such as Na₂CO₃ is introduced into Tank 83, and an appropriate amount of Na₂CO₃ solution is supplied to Reclaimer 94 depending on an amount of HSS in absorbent.

For drain water separated in CO₂ separator 48, which is otherwise returned to Desorber Column 40 via Water Washing Spray Section 44, some of it is pooled via Drain Line 49 depending on a liquid level of Reservoir Tank 83 through Flow Regulating Valve 81. An inorganic alkali salt (for example, Na₂CO₃) is introduced into Reservoir Tank 83 through Feeder 84 having weight monitoring capability. A flow rate of drain water is usually monitored with Flowmeter 82, but Level Indicator 85 may also be used for monitoring. The concentration of Na₂CO₃ in absorbent is adjusted by the flow rate of drain water and Na₂CO₃ supply, but the concentration may be measured and adjusted by sampling. Depending on the amount of HSS in absorbent, an appropriate amount of the Na₂CO₃ solution is supplied to Reclaimer 94 through Feed Pump 85 while monitoring a feeding mount with Flowmeter 87 so that the amount of HHS is not higher than a predetermined level.

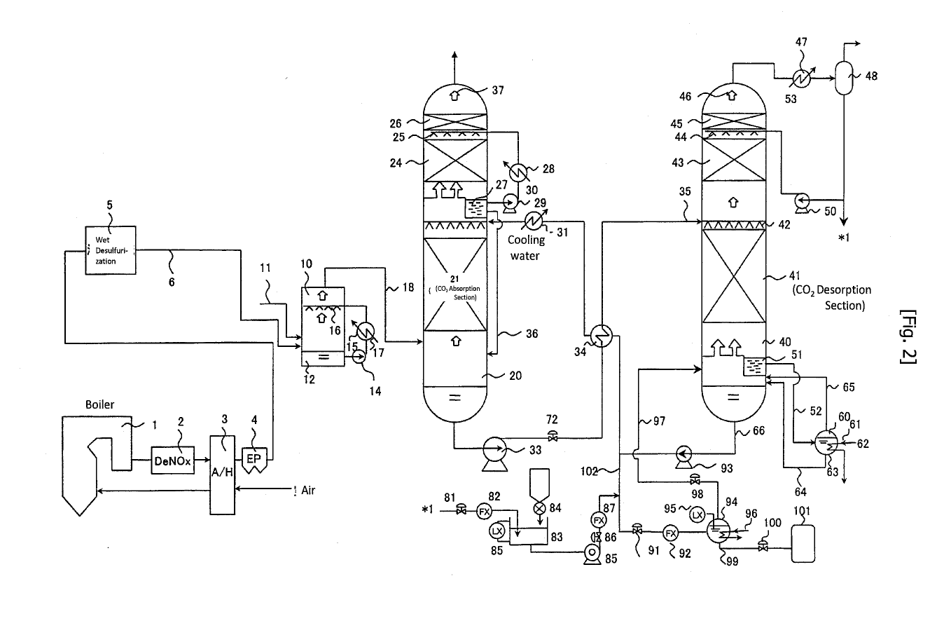

FIG. 2 shows another Embodiment of the present invention in which a feeding position is different from that of Embodiment in FIG. 1. The Na₂CO₃ solution is fed to Amine Feeding Line 102 upstream of Reclaimer 94 instead of Reclaimer 94.

The CO₂ absorption systems of FIGS. 1 and 2 have solved the problem of a water balance associated with operation of the reclaimer in the conventional system shown in FIG. 3. Even if there is no water supply from the outside of the system, the CO₂ absorption systems can be operated under optimal conditions.

### EXPLANATION OF SYMBOLS

1: Boiler

2: Denitration Device

3: Air Heater

4: Dry Electrostatic Precipitator

5: Wet Desulfurization Device

6: Exhaust Gas from Desulfurization Outlet

10: Pre-scrubber

11: Absorbent

12: Liquid Reservoir

14: Circulating Pump

15: Condenser

16: Spray Section

17: Cooling Water

18: Pre-scrubber Outlet Gas

20: Absorber Column

21: Packed Bed

22: Absorbent Spray Section

23: De-CO₂ Gas

24: Water Washing Section

25: Washing Water Spray Section

26: Demister

27: Absorber Column Washing Water Reservoir

28: Condenser

29: Washing Water Pump

30: Cooling Water

31: Condenser

32: Boiler Water

33: Absorber Column Withdrawal Pump

34: Heat Exchanger

35: Desorber Column Liquid Feeding Line

36: Washing Water Withdrawal Line

37: Treated Gas

40: Desorber Column

41: Packed Bed

42: Spray Section

43: Water Washing Section

44: Washing Water Spray Section

45: Demister

46: CO₂ Gas

47: Condenser

48: CO₂ Separator

49: Drain Line

50: Drain Pump

51: Desorber Column Liquid Reservoir

52: Reboiler Liquid Supply Line

53: Cooling Water

60: Reboiler

61: Steam Supply Line

62: Steam

63: Reboiler Liquid Reservoir

64: Reboiler Liquid Withdrawal Line

65: Vapor Supply Line

66: Desorber Column Liquid Withdrawal Line

67: Condensed Water Drum

68: Bypass Valve

69: Condensed Water Pump

70: Heat Exchanger Tube

71: Condensed Water Returning Line

81: Flow Regulating Valve

82: Flowmeter

83: Adjustment Tank

84: Feeder

85: Feeding Pump

86: Flowmeter

91: Cutoff Valve

92: Flowmeter

93: Pump

94: Reclaimer

95: Level Detector

96: Steam Supply Line

97: Amine Vapor Line

98: Cutoff Valve

99: Waste Amine Line

100: Cutoff Valve

101: Waste Amine Tank

102: Amine Supply Line

1. (canceled)

2. (canceled)

3. (canceled)

4. A method of controlling a CO₂ chemical absorption system comprising CO₂ chemical absorption equipment and absorbent regeneration equipment, the CO₂ chemical absorption equipment being involved in removing sulfur oxides in exhaust gas discharged from combustion equipment of fossil fuel by a flue gas desulfurization device, then contacting the exhaust gas with amine absorbent in a carbon dioxide (CO₂) absorber column to absorb CO₂ in the exhaust gas, subsequently heating the CO₂ absorbed absorbent in a desorber column to release CO₂, cooling the CO₂ released from the absorbent to separate condensed water, circulating the separated condensed water to the desorber column, heating the CO₂ released absorbent through a reboiler for circulation in the desorber column, heat exchanging the amine absorbent withdrawn from the desorber column with the amine absorbent to be supplied to the desorber column for circulation in the desorber column; and the absorbent regeneration equipment being involved in withdrawing the amine absorbent from the desorber column, removing heat stable salts accumulated in the amine absorbent by a distillation process, and then supplying resultant vapor of the amine absorbent to the desorber column, the method comprising rerouting some of condensed water obtained by cooling the CO₂ removed exhaust gas in the desorber column, and adding a solution of an inorganic alkali salt as a solvent to the absorbent regeneration equipment to remove heat stable salts accumulated in the amine absorbent in the distillation process.

5. The method according to claim 4, comprising: temporarily pooling the rerouted condensed water in an adjustment tank; adding inorganic alkali to the tank to adjust a concentration of the inorganic alkali and a liquid level; then adjusting an amount of the solution of the inorganic alkali salt in the adjustment tank, depending on a concentration of the heat stable salts in the absorbent to be supplied to the absorbent regeneration equipment; and adding the adjusted amount of the solution of the inorganic alkali salt to the absorbent regeneration equipment.

6. The method according to claim 5, wherein the inorganic alkali solution is added by pumping to an absorbent supply line leading to the absorbent regeneration equipment.

7. A method of recovering CO₂, wherein the method comprises:
(1) bringing an amine absorbent in contact with gas containing CO₂ for absorption of the CO₂ into the amine absorbent,
(2) heating the CO₂-absorbed amine absorbent to desorb the CO₂,
(3) cooling the desorbed CO₂ to obtain a condensed water, and
(4) removing a heat stable salts by preparing an inorganic alkali salt solution using the condensed water as solvent, mixing the inorganic alkali salt solution into the amine absorbent in which heat stable salts are accumulated, and distilling the mixture of the amine absorbent and the inorganic alkali salt solution, when the heat stable salts is accumulated in the amine absorbent.

8. The method according to claim 7, wherein the gas containing CO₂ is gas obtained by removing sulfur oxides in exhaust gas discharged from combustion equipment of fossil fuel.

9. The method according to claim 7, wherein amine absorbent vapor generated by the distilling is used for heating the CO₂-absorbed amine absorbent to desorb the CO₂.

10. The method according to claim 7, wherein the concentration and additive volume of the inorganic alkali salt solution is adjusted based on the concentration of heat stable salts in the amine absorbent.

11. A CO₂ chemical absorption system comprising:
an absorber column for bringing an amine absorbent in contact with gas containing CO₂ for absorption of the CO₂ into the amine absorbent,
a desorber column for heating the CO₂-absorbed amine absorbent to desorb the CO₂,
a condenser for cooling the desorbed CO₂ to obtain a condensed water an adjustment tank for preparing an inorganic alkali salt solution using the condensed water as solvent,
a reclaimer for distilling the mixture of the amine absorbent which a heat stable salts is accumulated in and the inorganic alkali salt solution,
a line for supplying the condensed water from the condenser to the adjustment tank, and
a line for supplying the inorganic alkali salt solution from the adjustment tank to the reclaimer.

12. The CO₂ chemical absorption system according to claim 11, further comprising:
a line for supplying the amine absorbent which a heat stable salts is accumulated in from the desorber column to the reclaimer, in which the line for supplying the amine absorbent is connected to the line for supplying the inorganic alkali salt solution.
